(19) United States
(12) Patent Application Publication
(10) Pub. No.: US 2022/0218086 A1
(43) Pub. Date: Jul. 14, 2022

(54) TAMPER-PROOF BAG AND SECURITY SYSTEM THEREFOR

(71) Applicant: ATECH S.R.L., Biella (IT)

(72) Inventors: Rodrigo SALMINCI, Biella (IT); Matteo ARNODO, Biella (IT); Luca AIAZZONE, Biella (IT); Alessandro ZANCO, Biella (IT)

(21) Appl. No.: 17/612,692

(22) PCT Filed: May 21, 2020
(86) PCT No.: PCT/IB2020/054828

§ 371 Date: Nov. 19, 2021

(30) Foreign Application Priority Data
May 22, 2019 (IT) 102019000007133

(51) Int. Cl. A45C 13/00; A45C 13/10; A45C 13/18; A45C 11/22

(52) U.S. Cl. CPC A45C 13/008; A45C 11/22; A45C 13/18; A45C 13/103

(57) ABSTRACT

A bag is described, provided with at least a closable aperture apt to be closed by way of a zipper provided with a slider body slidable according to a longitudinal axis along a double array of opposite teeth fastened to the edge of respective support ribbons, the support ribbons being fastened to the closable aperture, wherein the zipper has two laminae partly overlapping adjacent to the teeth and cantilever mounted from the support ribbons on an inner side of the closable aperture.

### CROSS-REFERENCE TO THE RELATED APPLICATIONS

This application is the U.S. national phase of International Application No. PCT/IB2020/054828 filed May 21, 2020 which designated the U.S. and claims priority to IT Patent Application No. 102019000007133 filed May 22, 2019, the entire contents of each of which are hereby incorporated by reference.

### BACKGROUND OF THE INVENTION

### Field of the Invention

The present invention relates to a tamper-proof bag, in particular a bag with a zipper opening and having tamper-proof security features.

### Description of the Related Art

As known, the bag sector comprises a complex universe, where very different needs coexist. Among the requirements that are often difficult to reconcile, there are fashion and technology. As a matter of fact, the combination of aesthetically pleasing aspects with solutions having an added technical value, also called “fash-tech”, is now sought after in the most diverse types of bags, from the most elegant shoulder ones, shoulder-strap or clutch ones, to the more sporty ones such as backpacks, pouches, bucket bags and duffle bags, to the more professional ones such as satchels, trolleys, suitcases, briefcases, etcetera.

Therefore, resorting to technology has proven paramount not only in contributing to the so-called “wow effect” of a bag, but also in the development of solutions apt in particular to the protection of the enclosed objects, such as for example the use of highly performing materials which make the bag extremely resistant to impacts, waterproof, cut-resistant and tear-resistant, guaranteeing at the same time protection from water, fire and dust.

However, it must be pointed out that these advantageous technical aspects do not always go well together with and match the more traditional aesthetic needs of bags. For example, an elegant and/or everyday bag normally has closing elements such as buckles, snap hooks, automatic buttons, rivets, clips, small straps, small laces, zippers, which are ill-fitted to the need to guarantee a security closing, sturdy and effective under intense perforation efforts.

In particular, among these closing elements, the zipper is the most suitable solution to join two opposite flaps in a quick and sealing manner, not allowing any passage of solids and fluids, and at the same time to show an appreciable aesthetic appearance, the zipper slider and teeth being highly versatile and agreeable. Per se, however, the zipper does not guarantee a significant security with respect to unauthorised opening.

In the prior art some solutions are available wherein security elements and systems applied to bags are nevertheless provided. As an example, WO201914504 discloses a bag comprising a rigid endoskeleton, an outer lining arranged on top of the rigid endoskeleton, a lock assembly coupled with the endoskeleton, a biometric sensor and a microcontroller. The lock assembly prevents access to the inner space when the lock assembly is in a locked condition. The lock assembly comprises a handle and an actuator.

The actuator is arranged inside the lock assembly to allow the lock assembly to selectively switch from a locked condition to an unlocked condition. The microcontroller is programmed to determine whether an input supplied to the biometric sensor corresponds to an authorised user and, in the affirmative, to trigger the actuator to allow the lock assembly to reach the unlocked condition and, in the negative, in order not to allow the lock assembly to reach the unlocked status. User identification systems are provided also in WO2017118919, which illustrates a closing device applied to a suitcase.

However, the known-art solutions, despite making use of special structural configurations, for example armored ones, and of effective electromechanical access systems to the inner chamber in connection with biometric readers for the identification of the authorised user, rely to bulky and little appealing lock systems and impose project constraints to the bag aesthetics, typically they do not provide the use of zippers.

Whereas instead the bags or suitcases employ zippers, in order to obtain anti-shoplifting features it is resorted to zipper-locking devices arranged outside the containment case; the locking devices are then normally applied to connect from the outside the pull tabs (or zipper tabs) either the bridges of two respective opposite sliders or to connect a pull tab or a slider bridge to a stop member fastened on the travel stop of the zipper. A typical example of this technology is disclosed in FR3008285. It is easily understood that such a locking device, visibly housed in the proximity of the zipper, is more exposed both to burglary actions and to atmospheric agents which inevitably reduce the useful life thereof.

Moreover, the fastening arrangement of the locking device inevitably offers attachment and hooking points to tools assigned to burglary actions, thereby easing lever actions to achieve tampering with a higher chance of success.

A different solution, wherein the slider lock is hidden from view, is illustrated in US2009/226050. In this document a slider locking mechanism of the zipper is disclosed, which acts from inside, by means of a pivoting fastening lever arrangement actuated by a solenoid valve. However, this mechanism has a certain bulk in the direction of the axis of movement of the slider. Moreover, providing actuation elements which have a certain degree of freedom in the zipper closing/opening direction, they are more vulnerable to a force action imparted directly onto the slider.

WO2018197170 illustrates a similar configuration.

Finally, WO2018186257 illustrates another security locking configuration for a zipper, wherein the locking element moves in a cross direction to the longitudinal axis of the zipper. This configuration requires, however, to build a special slider and is furthermore conceived with a complex and bulky actuation.

It must furthermore be noted that, in addition to the burglary action applied to the padlock or to the slider, a conventional zipper—despite the fabric of the edges being of material resistant to cutting and/or to perforation or despite the connections of the edges being robust with the bag fabric—it nevertheless offers a reduced resistance to perforation attacks directed precisely between the gaps formed during the coupling by the zipper teeth. In particular, imparting a pressure action with an awl between zipper teeth, it is possible to obtain a force component which mutually separates the zipper teeth and hence determines the unauthorised opening of the zipper.

The need is therefore felt to provide a bag which is capable of protecting its contents by means of a sturdy structure and a secure locking system applied to a zipper, arranged to close the bag inner chamber, and housed so as not to be exposed to atmospheric agents and burglary actions, furthermore avoiding configurations which are vulnerable with respect to forces directed in the zipper longitudinal direction. Finally, it is wished to provide a configuration which is also resistant to penetration actions with an awl.

### SUMMARY OF THE INVENTION

The object of the present invention is hence that of solving the drawbacks of the known art, providing a bag construction which allows to obtain an advantageous combination between aesthetics and burglary-preventing technical performances when the closing is provided with a zipper.

Such objects are achieved by means of a bag having the features disclosed and claimed.

### BRIEF DESCRIPTION OF THE DRAWINGS

Further features and advantages of the bag according to the present invention will in any case be more evident from the following detailed description of some preferred embodiments of the same, supplied purely as a non-limiting example and illustrated in the attached drawings, wherein:

FIG. 1 is a perspective view of an exemplifying bag according to a preferred embodiment of the present invention;

FIG. 2 is a perspective view of a locking device, connected to a biometric recognition device, according to a possible embodiment of the invention;

FIG. 3 is a partly-clear, raised front elevation view of the lock device of FIG. 2;

FIG. 4 is a perspective view of the anchoring system of the lock device of FIG. 2;

FIGS. 5A, 5B, 5C are similar views to those of FIG. 3, in three different operating steps, respectively;

FIG. 6 is a schematic side elevation view of another embodiment of a lock device according to the invention;

FIG. 7A is a cross-section view, in a partly exaggerated scale, of a zipper according to a preferred embodiment of the invention;

FIGS. 7B and 7C are photographs of various zipper embodiments manufactured according to what has been set forth in FIG. 7A; and

FIG. 8 is a cross-section view of a layering mode of the walls of a bag according to the present invention.

### DESCRIPTION OF THE PREFERRED EMBODIMENTS

In the context of the present application, by the term bag a portable container is understood, transportable by hand, with a shoulder strap or towed with wheels, to safekeep and carry personal objects, among which value objects.

A bag of this type typically consists of a closed container, having outside aesthetically pleasing, soft or semirigid walls, defining a closable mouth. This last one provides at least two opposite edges, hinged or flexibly connected to the remaining bag wall, which are equipped with two opposite components of a zipper, by which they can be steadily kept one next to the other so as to close the bag mouth.

A zipper, in a manner known per se, consists of a double opposite arrays of metal teeth (or other suitable material), apt to snap engage with the aid of a suitably shaped slider configured to slide constrained along the teeth. The two series of opposite teeth are constrained to the edge of respective opposite ribbons L, which make up the two components of the hinge and which are fastened (by sowing or gluing) to the mouth edges of a bag.

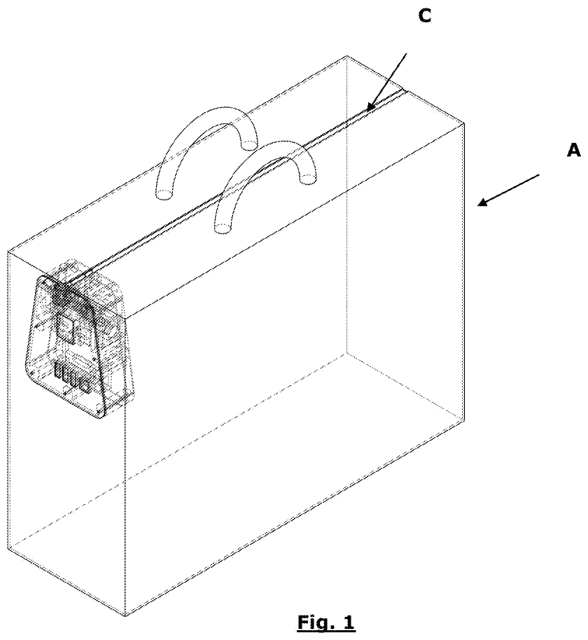

FIG. 1 shows an exemplifying bag A, provided with a zipper C arranged to close the mouth which gives access to one or more inner compartments. Zipper C comprises, in a manner known per se, a slider body Cu equipped above with a bridge P, for connection to a pull-tab (not shown).

According to a first embodiment of the invention, the slider body Cu is provided below with an arch E equipped with an engagement eyelet Ei. Preferably, engagement eyelet Ei is in the shape of a cylindrical hole with an axis orthogonal to the longitudinal plane of slider body Cu, that is, to the plane along which slider Cu is slidably guided in its opening/closing movement of the zipper.

In correspondence of the travel stop end of slider Cu along zipper C—that is the travel end which determines the closing of zipper C—bag A has a terminal side whereon a lock device 1 is arranged, fully housed below the plane of zipper C, that is within bag A.

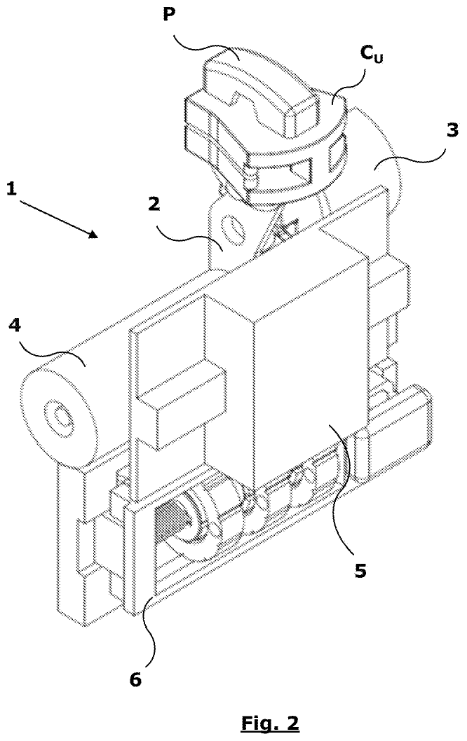

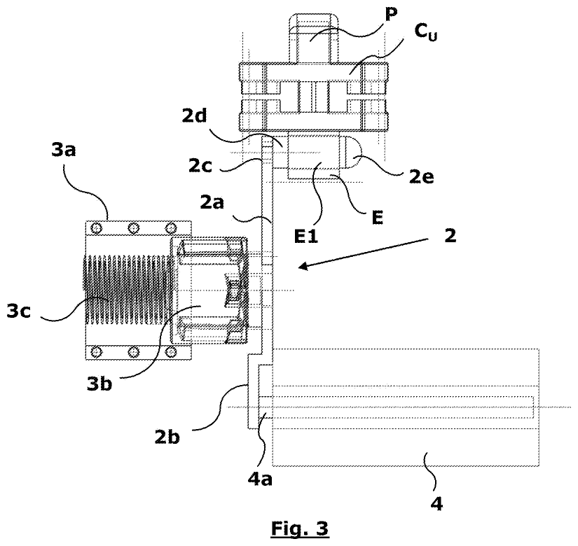

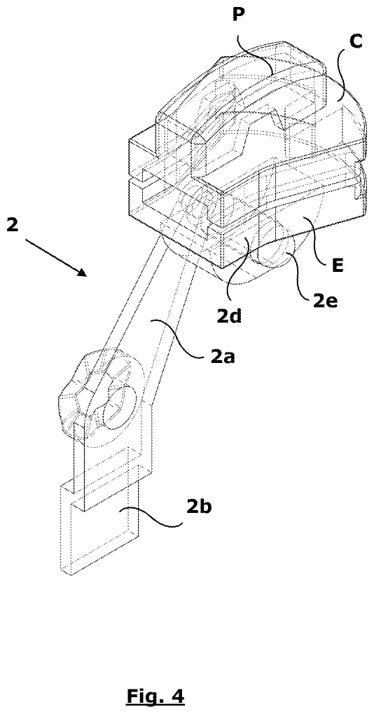

Lock device 1—as well shown in FIGS. 2 and 3—comprises a catch clip 2, a positioning mechanism 3 and a suitably controlled actuator 4.

Lock device 1 is housed in a compartment arranged within bag A, for example fastened integral to an endoskeleton—rigid, for example made of resin or metal sheet, or flexible—suitably provided among the layers which make up the walls of bag A.

Catch clip 2 is made up of a transmission arm 2a—preferably a flat bar of a metal material—constrained to a drive rod 4a of actuator 4 which is arranged to perform an alternate translation movement. The translation movement of the catch clip is orthogonal to the longitudinal axis of the zipper, along which slider Cu slides: that determines an intrinsic robustness of the system against the attempts to tamper the lock.

On transmission arm 2a a locking pin 2d is furthermore provided, arranged with an axis thereof parallel to the alternate movement direction of drive rod 4a. Locking pin 2d has a shape and section suitable to fit into the hole of eyelet Ei of arch E; the free end 2e of locking pin 2d is preferably rounded, for example semispherical, to ease the operation thereof which will be illustrated in the following.

Since locking pin 2d is meant to engage with eyelet Ei, the relative position between lock device 1 and the sliding plane of slider Cu is defined so that locking pin 2d finds itself on a translation axis in register with the position of eyelet Ei when slider Cu is at its travel end.

Transmission arm 2 is controlled in its alternated translation movement by actuator 4. Said actuator may be a manual control, but it is preferably an electromechanical actuator 4.

Actuator 4 according to the illustrated embodiment is of the solenoid type, comprising a ferromagnetic armature and an electric coil which, run-through by current, produces a translation movement of ferromagnetic control rod 4a slidably mounted on the central axis of the electric coil.

The system also provides an electric power accumulator, such as a battery, installed within a case of lock device 1 or in a remote position, for example underneath a bag bottom.

Electromagnetic actuator 4 can be configured for an active movement of rod 4a in the two directions; preferably, for sake of construction simplicity of actuator 4 and of the control thereof, it is provided, however, that the active actuation occurs only in one direction, while—in the opposite direction—movement is guaranteed by elastic elements provided in the positioning mechanism 3, as will be seen further on.

The operation of actuator 4 is controlled by a trigger unit, whereon a user can act to determine the opening of bag A. The trigger unit is arranged in the proximity of lock device 1, but at least a portion thereof—whereon the user must act—is configured to be able to protrude towards the outside of bag A through the wall thickness, typically in correspondence of the bag side A adjacent to the travel stop of slider Cu.

In the case of an electromechanical actuator 4, a suitable circuit is provided, by which it is connected to a source of electric energy, such as an electric accumulator located onboard of bag A.

The trigger unit is for example in the shape of a biometric recognition device 5. Preferably, said biometric recognition device 5 is a fingerprint reading and authentication device.

Alternatively or in addition, the trigger unit comprises a mechanical combination device 6 which enables the user to activate actuator 4, for example acting directly on drive rod 4a or on a manual switch (for example a button switch) which establishes the electric connection between the solenoid of actuator 4 and the source of electric energy.

Combination device 6 comprises, in a way known per se, a mechanical system which releases the switch whenever the correct numerical or alphanumerical combination has been entered on a plurality of maneuverable selectors—for example numbered small wheels. Combination device 6 can replace the biometric device or it can be used alternatively to biometric recognition device 5 in case of an electronic fault or of a full depletion of the supply battery or when the electronic components is in off-line mode.

At least a sensor of biometric device 5 and/or the selector of combination device 6 protrude outside of bag A.

According to a preferred embodiment, actuator 4 is of the single-effect type, hence it controls the translation of transmission arm 2a into a single direction.

In this case a positioning device 3 is provided which defines stable and unstable positions of transmission arm 2. For example, positioning device 3 has a hollow cylindrical body 3a, within which a gear plunger 3b, integral in movement with transmission arm 2a, and a return spring 3c are housed. Positioning device 3 operates in a manner similar to the snap mechanism used in ball pens to extend or withdraw the tip.

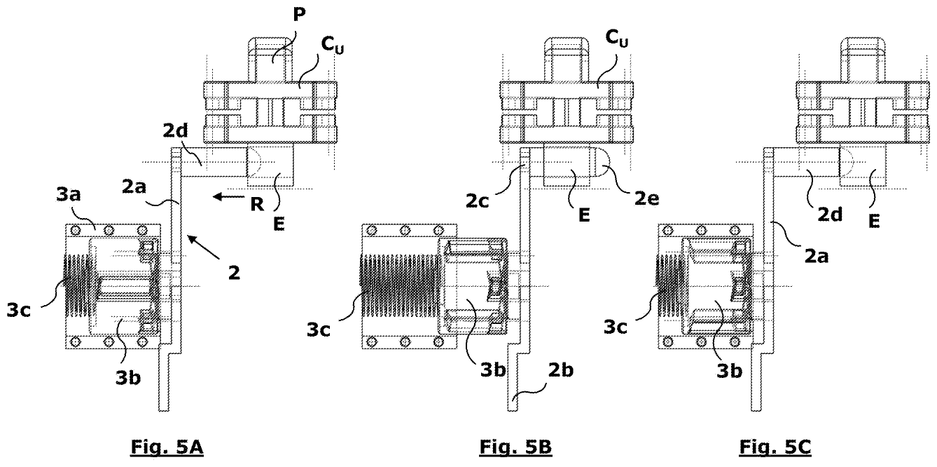

In particular, thanks to the configuration of gear plunger 3b and of the containment walls of hollow body 3a, the axial displacement of plunger 3b in opposition to return spring 3c, finds two different stability conditions. A first stability condition is the one shown in FIG. 5A, wherein plunger 3b is in a home position, with return spring 3c compressed and hence elastically loaded: in such position, transmission arm 2a is arranged so as to maintain locking pin 2d outside of the trajectory run by arch E, except for rounded end portion 2e. A second stability condition is the one illustrated in FIG. 5B, wherein plunger 3b is in a fully pulled-out position, with return spring 3c extended and unloaded. In the following the operation of lock device 1 according to the present invention is briefly described.

In a first step, starting from the condition with open zipper C, positioning device 3 rests in a home position. As clearly visible in FIG. 5A, transmission arm 2a keeps locking pin 2d spaced apart from the trajectory of above-lying slider Cu, except for head portion 2e. When slider Cu, pushed by the user, is moved into its travel end position, to close zipper C, arch E gets into abutment on rounded head 2e, hence pushing locking pin 2d—and consequently transmission arm 2a—to further move back (arrow R). Causing this back movement, return spring 3c is further compressed and the positioning mechanism loses its stability condition.

At this point, the elastic load accumulated in return spring 3c is released and biases forward (in the direction opposite to arrow R) with a remarkable force locking pin 2d. Since at the travel end of slider Cu, pin 2d is flush with the hole Ei of arch E, locking pin 2d is strongly biased into hole Ei (FIG. 5B). Please note that the insertion of locking pin 2d occurs in a direction orthogonal to the opening and closing direction of slider Cu along the longitudinal axis of the zipper.

A new stability condition is thereby reached, wherein locking pin 2d is in engagement with the hole Ei of arch E: slider Cu hence remains captured by lock device 1 and a sliding thereof along zipper C is no longer allowed, thus determining a security closure.

The condition of locked closure of slider Cu is hence obtained by means of an automatic snap of an elastic mechanism: no further active intervention by the user is necessary.

When it is instead necessary to proceed to release slider Cu, in order to be able to open zipper C, the user must act on the trigger unit to cause actuator 4 to make transmission arm 2 go back (arrow R) again, to withdraw the locking pin 2d from eyelet Ei (FIG. 5C). For such purpose, the user acts on biometric device 5 or on another equivalent mechanism, to toggle the switch and supply power to the solenoid of actuator 4.

It is understood that biometric recognition device 5 is kept in an on mode by the electric supply coming from the electric accumulator onboard the bag. If reading the fingerprint leads to the positive outcome of a valid authorisation, biometric recognition device 5 actuates actuator 4.

Actuator 4, itself supplied by the electric accumulator, pushes plunger 3b fully into cylindrical body 3a, causing at the same time a new elastic load of return spring 3c (which is thus suitably armed for the subsequent closing cycle): slider Cu is disengaged from pin 2d and is free to slide along zipper C. Once the action of actuator 4 has been released, plunger 3b is slightly pushed outwards by the bias of return spring 3c, until it returns into the first stable position illustrated in FIG. 5A.

Summarising, as long as the authorised user acts on the trigger unit, it is possible to pull—by means of the pull-tab—slider Cu, moving it away from the engagement position with security device 1 and thereby opening zipper C. When the user disengages the trigger unit, for example removing the finger from the biometric reading position, actuation 4 is deactivated, which discontinues the electromagnetic force imparted on moving rod 4a. At this point, once the thrust force has ended, return spring 3c begins to extend, causing the return of the positioning device to its stable condition of FIG. 5A.

As mentioned before, it is possible to use the fully mechanical device of combination device 6 as an alternative to using solenoid actuator 4 combined with biometric recognition device 5.

In addition, it is provided that both biometric recognition device 5 and combination device 6 may be physically separate and remote from security device assembly 1, with biometric recognition device 5 electrically connected to actuator 4 by wiring of electric wires of suitable length and combination device 6 mechanically connected to the transmission arm 2a of anchoring system 2 by means of a suitable system of rods of suitable length or by another mechanical device. All that in order to prevent burglary actions which may possibly succeed in removing biometric recognition device 5 and/or combination device 6 from its housing. Thereby it is possible to guarantee further protection to security device 1, housing it in a compartment embedded among the fabric layers, in a position difficult to reach—manually or through burglary means—through the housings of biometric recognition device 5 and of combination device 6, once they have been intentionally removed for criminal purposes.

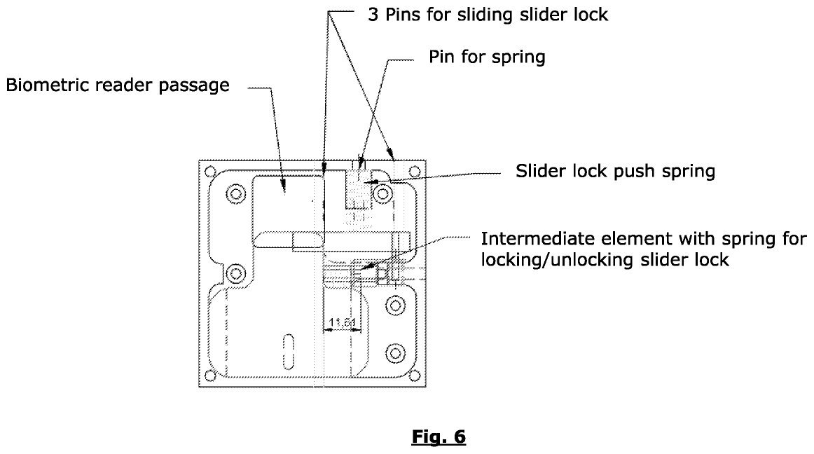

FIG. 6 shows a practical embodiment of the lock according to the invention, wherein the various components are housed in a containment body to be embedded in a bag wall.

According to a further aspect of the invention, in order to increase the security features of bag A, a peculiar construction of zipper C is provided, which makes it more resistant to undue opening attempts.

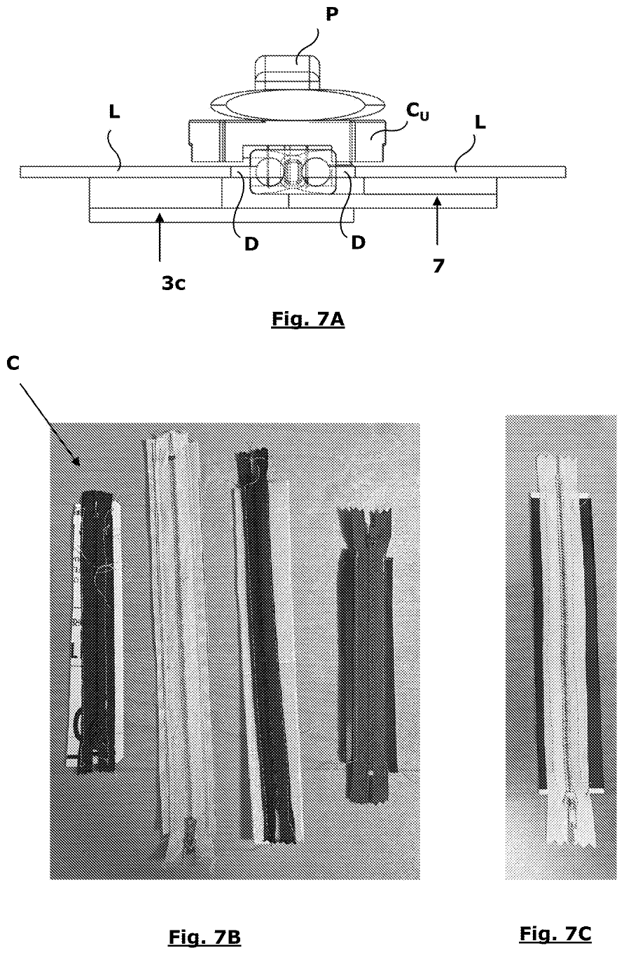

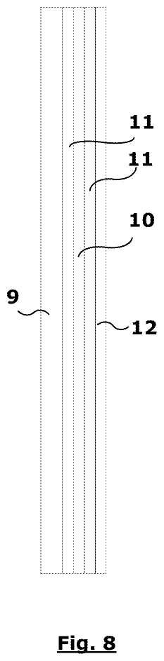

In particular, as illustrated in FIG. 7A, two laminas 7,8 of a semi-rigid material, for example polymer material, are provided, arranged underneath—i.e. on the inside of bag A—to the two components of zipper C.

The two laminas 7, 8, which project from the two opposite components of the zipper, extend crosswise to the zipper longitudinal axis by at least 10 mm and partly mutually overlap for a width of 2-15 mm.

Preferably, said laminas 7,8 are in the shape of lips sewn, for example by means of a nylon thread reinforced with polymer-matrix-fibres, on the support ribbon L of the two arrays of engagement teeth D of the zipper.

As represented in FIG. 6, the two opposite laminas 7,8 are mounted so as to partly overlap in correspondence of the longitudinal axis of slider Cu. Upon passage of slider Cu, the two laminas 7 and 8 can partly bend inwards, pushed by arch E.

By experimental tests it has been determined that the effectiveness of the two laminas is maintained for a series of different materials (see FIGS. 7B and 7C), such as polymer, polymer fabric, metal, cardboard, or other provided the nature of the material and the thickness of the lamina is such as to guarantee self-support of the lamina joined in a cantilever fashion onto the zipper portions. By self-support it is meant that the lamina, along its entire length crosswise to the zipper, cantilevered from the attaching line to support ribbon L, maintains itself substantially in a plane, without naturally bending from it (as would occur with very soft materials). This feature causes laminas 7 and 8 to keep in contact with each other and against the array of teeth D, when the zipper is closed.

Such a solution, extremely simple as it is, proves highly effective to withstand burglary attempts and to offer at the same time a rigidity increase to the flexural deformability of zipper C. In particular, such solution prevents to a greater extent the penetration action by tip loads applied in the gap between the coupled teeth, distributing and dampening the energy of such stress action applied to zipper C.

According to a further aspect of the invention, the structure of the container or casing defining bag A has a complex and layered configuration.

In particular, except for a portion of rigid endoskeleton apt to house security device 1—which is located for example on a lateral side of bag A—the wall of the casing is defined by the overlapping of layers of different materials as shown in FIG. 7.

For the outermost layer 9 leather is used, for example cattle leather of a thickness ranging between 0.8 and 1.8 mm, which, in addition to being waterproof and abrasion-resistant proves suitable to achieve a desired aesthetic finish.

In addition, more internally a protective multi-layer is used consisting of at least two overlapping layers of different material, in particular a sandwich-like arrangement which comprises a layer 10 resistant to shear forces, for example Cut-Tex® Pro material manufactured by PPSS Group, Wetherby, UK, inserted between two layers 11 of fire-proof material, for example Nomex® material manufactured by DuPont, Wilmington, Del., USA. The innermost layer 12 is a protective and finishing lining.

Such layering allows to obtain hence a casing which is resistant against shearing and perforation actions and which makes up a valid, flame-retardant thermal isolation. Finally, the inner lining consists of a conventional fabric suitable for aesthetic applications, such as for example synthetic fibres of polyester or polyester mixed with cotton. The use of further materials is not ruled out, for example layers of aramid synthetic fibre or other technical materials.

Preferably, on the bottom of bag A a protective case is provided, arranged in a suitable compartment inside bag A, containing an electric supply unit for device 1. The supply unit (not shown) comprises for example a lithium-ion (Li-Ion) accumulator or a lithium-polymer accumulator (Li—Po), as well as a main electronic board, comprising a microcontroller or a generic electronic processor, suitable for managing the peripheral electromechanical components onboard device 1, such as for example biometric recognition device 5 and actuator 4, but also the charge/discharge cycle of the supply battery which can be connected to a charger, for example through a mini-USB socket or similar universal socket.

Among the electronic components which can be provided, at least a communication module is also preferably installed in the electronic board, for example of the GSM, 4G, 5G, WiFi, Bluetooth type, and/or a geolocalisation module, for example of the GPS type.

If necessary, at least a speaker is also provided, for example a buzzer, arranged inside or outside bag A, meant to emit an acoustic alarm signal once a suitable movement sensor detects an unauthorised intrusion in the compartment of bag A.

In addition, in bag A a tracking system (known per se) is provided, which communicates with the outside by means of a receiving-transmitting circuit, which can employ various data transmission modules—some having been previously mentioned—in order to keep track of bag A and send the relative position to a dedicated server. In case of theft, it will hence be possible to learn in real time the position of bag A, making the recovery thereof easier.

Moreover, it is provided that said receiving-transmitting device is housed in a side of bag A inside a rigid container.

Moreover, a movement sensor is provided, for example a MEMS accelerometer, which detects the motion state of bag A in order to allow the management of the various electronic devices in energy saving mode.

As can be clearly understood from the above-reported description, bag A according to the present invention allows to perfectly achieve the set objects.

As a matter of fact, the bag A described here represents an effective solution to the need of being able to have available a portable container which is overall equipped with suitable devices which effectively contribute to the security of the goods kept inside it and, at the same time, is a product devoid of excessive constraints from an aesthetic point of view, due to the fact that it provides a security zipper.

In particular, due to the presence of security device 1, it effectively solves the above-mentioned problems, having a sturdy, accurate, fast-actuating and constructively simple blocking system of the slider Cu of zipper C. Moreover, said security device 1 is arranged within the compartment, so as not to be exposed to direct burglary attacks.

Moreover, the strengthening effect offered by the laminae underneath zipper C proves to be a suitable solution to withstand perforation actions on zipper C, said zipper conventionally being an easy and fast closing means but characterised by reduced resistance to perpendicular shearing stress.

Again, the use of overlapping layers of different material, each with its own performing function, defines a bag A having high shear resistance, perforation resistance and flame resistance and with waterproof features.

Finally, in the event that a theft is carried out, bag A can be easily tracked by means of the tracking and geolocalisation device, which is embedded within the reinforced fabric and protected by a sturdy container, steadily fastened to the main structure of bag A in order to inhibit the evildoer's intentions to tamper with it.

It is understood, however, that the invention must not be considered limited to the particular arrangements illustrated above, which make up only exemplifying embodiments thereof, but that different variants are possible, all within the reach of a person skilled in the field, without departing from the scope of protection of the invention, which is only defined by the following claims.

For example, although reference has always been made to an arch in the inner part of the zipper slider, it is understood that the shape thereof must not necessarily be in the shape of an arched circle, provided it has the engagement eyelet.

1. Bag provided with at least one closable aperture rim apt to be closed by means of a zipper equipped with a slider body slidable according to a longitudinal axis along a double array of opposite teeth fastened to the edge of respective support ribbons, the support ribbons being joined to said closable aperture rim, wherein
said zipper has two laminae partly overlapping adjacent to said teeth and cantilever mounted from said support ribbons on an inner side of said closable aperture rim.

2. The bag of claim 1, wherein said laminae overlap for a width of at least 2 mm.

3. The bag of claim 1, wherein said laminae extend in a direction orthogonal to said longitudinal axis by at least 10 mm.

4. The bag of claim 1, wherein
slider is provided with a lower arch on the inner side of the zipper, and furthermore comprises a lock device to lock in position said slider body, wherein
said arch is provided with an engagement eyelet which provides a hole with an axis substantially orthogonal to a longitudinal plane of said slider body,
said lock device is housed in the proximity of a travel stop end of said slider body, fully below the inner side of said zipper, comprising at least a catch clip and a positioning mechanism, and wherein
said catch clip has at least a transmission arm constrained to said positioning mechanism and to a drive rod of an actuator, and carrying a locking pin arranged with an axis thereof parallel to a direction of alternate movement of said drive rod and in register with said engagement eyelet when said slider body is in said travel stop end thereof,
said positioning mechanism having at least two different stable positions, in one of which an elastic element is elastically loaded.

5. The bag of claim 4, wherein said actuator comprises an electromechanical control.

6. The bag of claim 4, wherein said actuator is controlled by a trigger unit, protruding towards the outside of said bag.

7. The bag of claim 6, wherein said trigger unit is in the shape of a biometric recognition device.

8. The bag of claim 4, wherein said actuator comprises a mechanical selector device.

9. The bag of claim 4, wherein a power supply unit is also provided for at least said actuator, comprising an electrical accumulator and an electronic control board.

10. The bag of claim 7, wherein said electronic control board furthermore comprises a mobile telephony communication module, a geolocalisation module, a Bluetooth® communication module and a recharge module of said electrical accumulator.

11. The bag of claim 10, wherein said electronic control board furthermore comprises a motion sensor module.

12. The bag of claim 1, wherein a casing of said bag comprises a layered wall consisting of at least an outer layer of aesthetic material, a cut-resistant layer, a flame-resistant layer and an inner finishing lining layer.

13. The bag of claim 2, wherein said laminae extend in a direction orthogonal to said longitudinal axis by at least 10 mm.

14. The bag of claim 2, wherein
slider is provided with a lower arch on the inner side of the zipper, and furthermore comprises a lock device to lock in position said slider body, wherein
said arch is provided with an engagement eyelet which provides a hole with an axis substantially orthogonal to a longitudinal plane of said slider body,
said lock device is housed in the proximity of a travel stop end of said slider body, fully below the inner side of said zipper, comprising at least a catch clip and a positioning mechanism, and wherein
said catch clip has at least a transmission arm constrained to said positioning mechanism and to a drive rod of an actuator, and carrying a locking pin arranged with an axis thereof parallel to a direction of alternate movement of said drive rod and in register with said engagement eyelet when said slider body is in said travel stop end thereof,
said positioning mechanism having at least two different stable positions, in one of which an elastic element is elastically loaded.

15. The bag of claim 3, wherein
slider is provided with a lower arch on the inner side of the zipper, and furthermore comprises a lock device to lock in position said slider body, wherein
said arch is provided with an engagement eyelet which provides a hole with an axis substantially orthogonal to a longitudinal plane of said slider body,
said lock device is housed in the proximity of a travel stop end of said slider body, fully below the inner side of said zipper, comprising at least a catch clip and a positioning mechanism, and wherein
said catch clip has at least a transmission arm constrained to said positioning mechanism and to a drive rod of an actuator, and carrying a locking pin arranged with an axis thereof parallel to a direction of alternate movement of said drive rod and in register with said engagement eyelet when said slider body is in said travel stop end thereof,
said positioning mechanism having at least two different stable positions, in one of which an elastic element is elastically loaded.

16. The bag of claim 5, wherein said actuator is controlled by a trigger unit, protruding towards the outside of said bag.

17. The bag of claim 5, wherein said actuator comprises a mechanical selector device.

18. The bag of claim 6, wherein said actuator comprises a mechanical selector device.

19. The bag of claim 7, wherein said actuator comprises a mechanical selector device.

20. The bag of claim 5, wherein a power supply unit is also provided for at least said actuator, comprising an electrical accumulator and an electronic control board.
